(19) United States
(12) Patent Application Publication
(10) Pub. No.: US 2017/0024790 A1
(43) Pub. Date: Jan. 26, 2017

(54) METHOD AND SYSTEM FOR TRACKING AND REWARDING SELECTABLE INDIVIDUALIZED USER MENU/RECIPE/CONSUMER PRODUCT COMBINATIONS

(71) Applicant: Frank S. MAGGIO, Pinellas Park, FL (US)

(72) Inventor: Frank S. MAGGIO, Pinellas Park, FL (US)

(21) Appl. No.: 15/215,552

(22) Filed: Jul. 20, 2016

Related U.S. Application Data
(60) Provisional application No. 62/194,286, filed on Jul. 20, 2015.

(51) Int. Cl. G06Q 30/06; A63F 13/92; H04N 7/18; A63F 13/213; G06F 3/0482; G07F 17/32

(52) U.S. Cl. CPC G06Q 30/0621; G06F 3/0482; G07F 17/3258; G07F 17/3209; G07F 17/3218; G07F 17/3206; H04N 7/188; A63F 13/213; A63F 13/92; G06Q 50/12

(57) ABSTRACT

A system and method are provided for uniquely automating and otherwise gamifying a user selection of a particular “recipe” for user-chosen ingredients for a particular beverage or meal (salad, sandwich or the like), and more broadly to any category of consumer goods that may include a menu of user-selectable randomization or customization accessories, with an objective of attracting high levels of potential consumer and/or customer traffic to a particular brand that incorporates the disclosed gaming schemes. The disclosed schemes simplify hosting of, and participation in, a unique implementation of a particular automated game to stimulate customer and/or consumer interest by rewarding unique combinations of user-selected features for customizable products.

### BACKGROUND

This application claims priority to U.S. Provisional Patent Application No. 62/194,286, entitled “Method And System For Tracking And Rewarding Selectable Individualized User Menu/Recipe Combinations” by Frank S. Maggio, filed in the U.S. Patent and Trademark Office on Jul. 20, 2016, the disclosure of which is hereby incorporated by reference herein in their entirety.

1. Field of the Disclosed Embodiments

This disclosure relates to systems and methods for uniquely automating and otherwise gamifying a user selection of a particular “recipe” for user-chosen ingredients for a particular beverage or meal (salad, sandwich or the like), and more broadly to any category of consumer goods that may include a menu of user-selectable randomization or customization accessories, with an objective of attracting high levels of potential consumer and/or customer traffic to a particular brand that incorporates the disclosed gaming schemes.

2. Related Art

Modern widespread computer-based data collection and analysis capacity and capabilities are exploited by those involved in a broad spectrum of commercial activities. Commercial entities involved in finance, manufacturing, marketing/advertising, sales and other widely varied and far-reaching commercial activities have embraced various forms of business intelligence (BI) to improve their market share, brand exposure, customer attraction and/or overall customer base in a manner that is designed to increase their productivity and profits.

Modern BI generally refers to a broad range of simple to sophisticated schemes that rely on varying levels of automated data collection and decision support services to execute techniques for transforming the raw data collected from multiple sources into usable information for business analysis purposes. Sophisticated BI schemes collect large amounts of data on general or specific trends in a particular market sector, a particular geographic market segment, and/or a particular demographic, among other descriptors, to provide, for example, to a particular business entity an analysis in a particular level of detail to help identify and/or develop: (1) new strategic business opportunities; (2) targeted marketing/advertising schemes; (3) metrics for measuring brand awareness within, or attractiveness to, a particular geographic or demographic population; and (4) other like business objectives for the particular business entity, or more generally for commercial enterprises participating in the market sector or market segment under scrutiny.

An objective behind the broad implementation of such BI schemes is to allow for straightforward interpretation of large volumes of data to the benefit of the commercial enterprise. Identifying opportunities and implementing organizational and operational strategies based on the insights gained from the BI schemes can provide businesses with competitive market advantages increasing their stability and profitability in the marketplace.

In the retail market space, merchants and service providers focus not only on streamlining their organizations and/or optimizing their operations, but also on managing, advancing and generally improving the relationships with their customers. In this regard, a class of focused schemes related to BI has emerged. These schemes are often referred to as customer intelligence or CI, which is generally considered to be a key component of effective customer relationship management or CRM. CI schemes focus on the collection and analysis of information regarding customers and/or consumers, including their purchasing and consuming activities, the stores and establishments they frequent, their shopping “trends,” and the “preferred” retailers and/or service providers with whom they most favorably and/or most often interact.

Merchants and service providers employ the information generated by the CI schemes to build deeper and more effective customer relationships, target potential customers, provide incentive and reward programs and otherwise find ways to attract new customers while retaining current customer populations. The information collected on the behavior and experience of a company's current and prospective customer base can prove invaluable in furthering the objectives of other BI initiatives in improving that particular company's stability and profitability in the marketplace. Over time, a particular company's ability to quickly respond to changing customer needs or “wants” will lead to a sustainable competitive advantage and sustained growth and profitability over time, particularly as the consuming populace, along with variations and customer and consumer trends in the marketplace, changes and evolves.

Increasingly, merchants and service providers have sought to employ schemes for tracking stable and emerging trends in customer and/or consumer behavior, most often in a manner in which the data collection function is substantially transparent to any particular customer or consumer. Digital menu screens, for example, that present to a particular customer and/or consumer details regarding his or her order require the input of particular information by category, along with any particular “changes” that the customer or consumer may desire, according to his or her taste, to “get their order right.” In this manner, a retail fast food establishment, for example, is able to collect information not only on how many “Super X” sandwiches are sold, but on how many such sandwiches are sold with or without cheese, with or without pickles, finished with certain combinations of condiments, á la carte or as part of a combo meal, and how often the meal is up sized to become the establishment's signature “Best Value Super Duper Super X Meal.”

All of this data is capturable, and most often captured, by background data collection systems for detailed analysis according to any particular enterprise's business objectives.

### SUMMARY

CI is applicable across all categories of retail enterprise. These categories may include, but not be limited to credit card service providers, wireless service providers, automobile dealers and service centers, soft drinks and beverage companies, and a broad array of traditional “brick and mortar” establishments including “Big Box” and other retail stores, Do-It-Yourself hardware stores, drug and/or convenience stores, and quick service and casual dining restaurants.

In the area of restaurants in general, CI often begins with establishing certain facts about the consumer population including geographic location and local demographics. Particulars regarding individualized or recurring transactions are then included. Types of information collected may include current purchase information, purchase history information, interactions from service contacts over the phone and via e-mail, monitored online information gathering or shopping trends and other like information. Increasingly, companies are supplementing this information with customer satisfaction surveys and other similar targeted information gathering schemes. The trend toward online ordering for pickup at a particular location offers an opportunity to collect even more detailed information regarding individual customers and/or consumers. Further, as the use of mobile digital platforms, generally in the form of smart phones and/or tablets, becomes more ubiquitous in the commercial transaction process, customers and/or consumers may enter pre-order information into their devices to streamline the information exchange requirements associated with making and paying for their particularly customizable order. The trend toward inclusion of digital information exchange facilitates the capacity by which a particular enterprise made populate its CI databases with more particularly-granular and individually-targeted consumer or customer information.

The above trends make available to a broader spectrum of merchants and service providers' information that may have been previously typically reserved to, for example, concierge services and higher end restaurants and accommodations. Particularly, CI analysis is becoming so granulated that when a “known” diner enters the establishment, for example, identified by a presence of his or her mobile communicating device, the establishment may be able to generally predict what the diner may order. Commercial diner specific CI systems exist to provide targeted analysis of frequent customers. Diner preferences and payment histories are tracked with an objective of offering certain “VIP” services to loyal diners. The restaurant may use CI information to send targeted offers based on the days and times when certain customers are most likely to dine. Guest management and loyalty platforms seek to incentivize consumers to dine more often. Point of sale or POS systems in the restaurants allow the restaurants to track their guests' purchases, preferences and methods of payment, average check amounts, favorite menu items, and favorite drinks. Servers may be directed to use this information to provide diners with an informed dining experience, and, for example, avoiding recommendations that may be not to the diners' liking.

Separately, restaurants may provide an interactive learning experience while guests wait to be seated to collect information on dining preferences and on the diners themselves in an apparently non-intrusive manner. These information collection tools may be implemented through the diner's smartphone based on the number being given to the hostess or host for paging once a table becomes ready. Online reservation tools may implement similar interactive inquiries collecting, for example, the diner's email address and any special requests pursuant to collecting reservation information that may be used for future marketing purposes. Restaurants can create detailed guest profiles with complete histories that show exactly which dates and times a customer has come in, along with the party size and length of time that person waited for a table at each visit, with a place for restaurant employees to store any information they collect from customers once they arrive, like favorite wines, food allergies, or favorite tables.

Certain schemes allow customers to earn points and rewards based on their spending habits at participating establishments, and in return restaurants get access to diner data that can be used to identify trends and segment customers. In establishments that have implemented, for example, tablet-type table management systems, the restaurant may present an interactive survey-type application to collect information that may permit the establishment to gain a better understanding of its guests. Servers may add notes or choose from a list of selectable identifiers to provide simple customer profiles to which they can refer back as a refresher on diner preferences and dislikes each time a particular diner comes in. In general, implementing any ability to track customer preferences may enable the restaurant to tailor its services to individual needs. The more that the particular restaurant can make the data collection scheme appear to be no more than a non-intrusive, interesting game-like display to be interacted with as a way of passing time, the better the collection scheme may be received.

The above models and CI schemes, which traditionally worked well in more traditional “sit-down” formal dining establishments, were, until recently, not as easily integrated into quick service restaurants (QSRs) and other casual dining establishments. The QSR environment is among the most competitive, relying on customer preference to grow its consuming population, thereby multiplying small per diner profit margins across large numbers of diners to provide an overall profitability structure. Implementing unique schemes for incentivizing customer and consumer loyalty in an environment where very little information has conventionally been collectible, or otherwise collected, on each consumer may provide a unique opportunity to outpace competition in individual markets.

As technologies advance in POS, mobile payments, and food/beverage dispensing and automation, an ability for merchants and manufacturers to have precise knowledge of product consumption and transaction behavior has evolved to become more commonplace in virtually all segments of the food and beverage industry. This technology infrastructure, further enhanced by other supporting schemes including, for example, the Internet of Things (IoT) phenomenon, is enabling consumers to make more choices of a particularly-established menu of options, including nuanced combinations of ingredients.

Subway and Starbucks are among the sorts of franchised QSRs that provide customers/consumers a true opportunity to have it their way. While waiting for your medium cup of coffee with two creams and a sugar, you may overhear the person in front of you ordering the large latte with two pumps of vanilla syrup, a shot of peppermint, soy milk and a whipped topping with a squirt of caramel. One wonders why that person did not “phone in” their order, thereby reducing your wait time to get your coffee. In some instances, this ability to customize products extends to the actual creation or mixing by the consumers themselves, of uniquely constructed mass produced food or beverage products, taking the traditional salad bar combination of ingredients a step further, as opposed to merely allowing this customization to be enabled or produced by merchants or manufacturers.

It would be advantageous to gamify the customer or consumer interactive ordering experience, particularly regarding user-selectable options for concocting a particular recipe, in a manner that takes advantage of the modern migration to customized choice in mass food and beverage merchandizing.

Exemplary embodiments of the systems and methods according to this disclosure may provide an automated technique whereby a customer or consumer “recipe” regarding a particular combination of features for a particular consumer product, beverage or meal may be collected as an input in a gaming process.

Exemplary embodiments may compare a customer or consumer selected recipe of ingredients to a pre-selected combination of features (or ingredients) established for a given time period, and award prizes based on a result of the comparison. In embodiments, prizes may be awarded in a lottery type hierarchy based on a number of specified “ingredients” in a particular customer or consumer recipe matching one or more of the ingredients in the pre-selected combination of features (or ingredients).

Exemplary embodiments may provide an ordering or dispensing kiosk at which a customer or consumer enters the recipe to record or collect identifying information from the customer or consumer for use in concocting the customer or consumer customized order and also in populating a customer/consumer database with information on the customer/consumer, and his or her feature, ingredient, menu, recipe or feature preferences.

In embodiments, the kiosk may include a video or still camera by which images of the customer or consumer are recorded for use in subsequent marketing schemes, particularly to recognize and store the identity of the user, and to record customer or consumer responses to the award of prizes based on their individual menu selections.

Exemplary embodiments may allow the customer or consumer to record a particular identifier or assign unique avatar for the customer or consumer recipe to be shared with others as a unique and personal combination identifier.

In embodiments, a particular customer or consumer may be awarded certain prizes for others ordering or sampling a product according to the particularly-identified customer or consumer recipe.

These and other features, and advantages, of the disclosed systems and methods are described in, or apparent from, the following detailed description of various exemplary embodiments.

### BRIEF DESCRIPTION OF THE DRAWINGS

Various exemplary embodiments of the systems and methods for uniquely automating and otherwise gamifying a user selection of a particular “recipe” for user-chosen ingredients for a particular beverage or meal (salad, sandwich or the like), or more broadly to any category of consumer goods that may include a menu of user-selectable randomization or customization accessories, with an objective of attracting high levels of potential consumer and/or customer traffic to a particular brand that incorporates the disclosed gaming schemes, according to this disclosure, will be described, in detail, with reference to the following drawings, in which:

FIG. 1 schematically illustrates an exemplary embodiment of a menu-type display, which may be presented on a restaurant tablet-type ordering device, at an ordering kiosk, on a beverage dispenser, according to a handheld mobile device or wearable device application, via a Web page or the like, by which a user may enter a recipe for a product from selectable options as an entry to a gamified customization scheme according to this disclosure;

FIG. 2 schematically illustrates an exemplary embodiment of a user data collection display, which may be presented on the restaurant tablet-type ordering device, at the ordering kiosk, on the beverage dispenser, or the like, by which a user may be prompted to enter user identifying information to be associated with the recipe for the product selected on the menu-type display of FIG. 1 and according to this disclosure;

FIG. 3 illustrates a block diagram of an exemplary system for implementing a menu and user recipe type gaming scheme according to this disclosure; and

FIG. 4 illustrates a flowchart of an exemplary method for implementing a menu and user recipe type gaming scheme according to this disclosure.

### DETAILED DESCRIPTION OF EMBODIMENTS

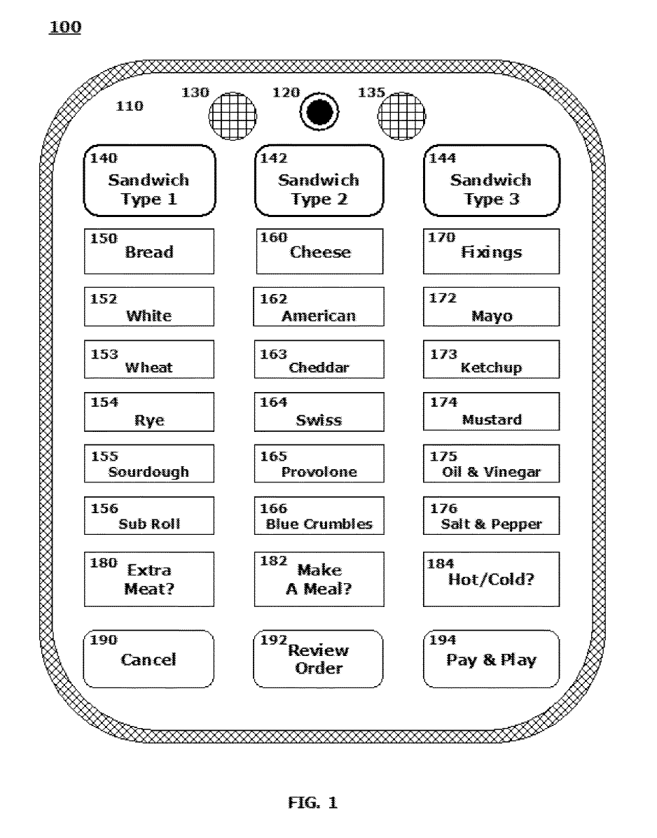

The systems and methods for uniquely automating and otherwise gamifying a user selection of a particular “recipe” for user-chosen ingredients for a particular beverage or meal (salad, sandwich or the like), or more broadly to any category of consumer goods that may include a menu of user-selectable randomization or customization accessories, with an objective of attracting high levels of potential consumer and/or customer traffic to a particular brand that incorporates the gaming schemes according to this disclosure will generally refer to this specific utility for those systems and methods. Exemplary embodiments described and depicted in this disclosure should not be interpreted as being specifically limited to any particular physical configuration of a user interactive computing device, whether a stand-alone device, a kiosk, a dispenser-mounted device or the like, or a user mobile or augmented reality computing or communicating device or to any particular class of or protocol for, networked communication among such devices for interaction with and among participating users. Any electronic display component, which may display, for example, a menu-type matrix such as that shown in FIG. 1 may be usable to implement the disclosed schemes. Such display screens may include those associated with, for example, an Internet-based implementation accessed through a host website as well. Further, such display screens may be presented on augmented reality glasses which may project the viewable display onto a transparent reflective material, or even into the retina of the eye itself. In embodiments, a presence of a user may be detected in a cooperating or participating place of business through interpretation via voice or facial recognition (derived from Internet or other search database-connected cameras, or other detectable biomarker technologies adapted to recognize an individual's unique presence via the individual's unique physiological attributes).

Conventionally, user selection of individual preferences compared to a pre-selected menu scheme can be traced back to the 1970′s and earlier, including Burger King's® popular “Have it Your Way” campaign, where consumers were empowered to order customized burgers, with the staff “building the burger” customized to the precise ingredients requested by the customer. This freedom of choice resonated with customers and consumers who had been accustomed to believing that affordable foods that were mass produced, were more affordably priced than their more expensive “dining room” equivalents, in large part due to the automation that expedited preparation of the individual menu selections, while standardizing all the products (and eliminating choice).

This paradigm was previously illustrated in the automotive industry by the Ford Motor Company®, which developed and used the assembly line to build more cars, more quickly and more affordably, but with limited choices (as opposed to the powered carriage manufacturers that handmade and custom made automobiles.) As Henry Ford is reported to have famously stated, “You can have any color as long as it's black.”

Today, companies that are able to provide customization in fields formerly dominated by automated “cookie cutter” product manufacturing are gaining market share. Examples include Vans®, Converse®, Zappos® and others in the shoe industry, who are selling “custom” shoes online as particularly designed by individual customers to be unique to those individual customers. Such customization was generally unheard of even a decade ago. Where individual design choices used to be limited to a particular menu of specified colors or color combinations according to certain size ranges, now colored or patterned panels of shoes, insoles, precise custom sizing and personalized logos are generally available to customers and consumers in an online marketplace.

Do-it-yourself (DIY) food bars and even pizza bars are now allowing customers and consumers to order unique combinations of foods, often “built to order,” with some food and salad bars allowing consumers to create their own meals and mixtures of varied ingredients. The ingredients can be monitored and charged by category, and where necessary, weighed, either in bulk, or based on the price level of product. For example, meats and proteins may cost more than pastas and salad ingredients/fixings.

In the carbonated beverage industry, the traditional self-serve fountain “stations” have two to eight or more do-it-yourself spigots of two to eight or more flavors of premixed syrup, mixed with water and carbonation. The “creative” consumer may create his or her own unique mixture by holding their ice-filled cup below the independent spigots and depressing the valve controls until the estimates desired amount of each component flavor is dispensed. This conventional manual mixing operation has recently given way to a newly automated dispensing scheme in which increased numbers of individual “flavors” are being dispensed in a uniquely exciting and customer enticing manner. The soda bars in many QSRs are being replaced by a single dispenser unit by which, using an interactive series of touchscreens, a consumer is afforded an opportunity to uniquely concoct the “perfect” mixture of component flavors. One example of such a beverage dispenser is provided by the Coca Cola Bottling Company® as its Coca Cola Freestyle® machines. Using flavor cartridges, and RFID chips and other technology to measure, dispense and record syrup doses (and to report on metrics including syrup product remaining), these next generation machines dispense combinations of flavors and quantities, allowing for an advertised “125 different flavors.” While there will certainly be those, who like the customer ordering the medium cup of coffee with two creams and a sugar, will remain with the traditional “straight up” beverage over ice with which they and their taste buds are familiar, the modern “have it your way” aficionado will likely seek to explore that perfect combination flavor components that, once determined, will be repeatable over and over again given the precise control of ingredient flavors now afforded to the customer or consumer.

In reality, because machines can offer varied quantities of each flavor, the number of unique (and repeatable) flavor combinations is virtually limitless, when taking into consideration that an amount of one particular flavor (say lemon) may have an influence on how “lemony” a product may become versus other combined flavors, or even water and its dilution impact on flavor. While the automated machines may allow a user to select a flavor combination with a name (“Cola Limola”), and the machine may then create the consistently mixed combination by ensuring the same mix of flavors is added and mixed each time, alternative embodiments may be expanded in a manner that enables a customer/consumer to specify percentages or dram amounts of each desired flavor.

In such embodiments, customers/consumers may be afforded an opportunity to enjoy complete control of products “seasoned” to their particular tastes, including their own preferred flavors that may be obtained through a customer/consumer taste experimentation process. Machines automated to precisely control a customer/consumer ordered mixing process may also return to the customer/consumer a tabular readout, for example in the form of a receipt, that may allow the customer/consumer to refine his or her experimentation process or to record the “perfect” flavor mixture. Separately, the dispenser may obtain the identity of the customer/consumer, via voice or facial recognition or other “biomarker technology,” or request identifying information for the customer/consumer including an email address to which the menu for the final or preferred concoction may be sent, thereby unobtrusively collecting additional CI on the consumer or customer with the unique recipe. As another option, a near field communication (NFC) or optically scannable code may be used to record the “recipe” to or from a user's mobile device. Any of these methods would provide the customer/consumer with the uniquely enjoyable ability and/or opportunity to re-order the precise flavor combination in subsequent visits to the machine either through manual interaction with the interactive display components of the machine or by presenting an NFC or optically scannable code to the machine for interpretation. In embodiments, customers or consumers may be afforded the option of uniquely naming their concoction, such as “Frank's Cola Over Orange Lite (F-COOL),” the recipe for which could be shared with family and friends and replicated at multiple machines.

The systems and methods according to this disclosure will be described as being particularly adaptable to enhancing a gamification experience related to customization of a sandwich that may be ordered on a tablet type ordering component at a counter in a QSR. The disclosed systems and methods may have the additional advantage of collecting demographic (and even personal) information regarding customers or consumers participants in a manner that provides the QSR, or a related advertiser or marketer, with a body of analyzable data regarding those customers or consumers in order to target marketing schemes and, for example, reactive advertising content at those customers or consumers. In this regard, an amount of BI regarding the particular customer or consumer population frequenting that QSR may be collected and made available or otherwise provided for use. Specific references to gamification and information exchange schemes are meant to be illustrative only in providing examples of real-world utility for the disclosed systems and methods, and should not be considered as limiting the disclosed systems and methods to any particular customizable product including, but not limited to, beverages, meal components, or even, for example, consumer products. Throughout the balance of this disclosure the use of the terms “product” and “products” are intended to refer to individual customizable products such as, for example, a sandwich or a beverage that may be purchased at a QSR, or to combinations of multiple individual product that may be purchased as a group, e.g., a “meal” including individually customizable elements that may be purchased as a group. Outside the QSR context, imagine an opportunity to go on a car company website and “build your own new vehicle” only to find that your undertaking of that effort results in a coupon for a significant reduction in the purchase price of the online designed vehicle, or ultimately a grand prize of the award of such a custom-designed vehicle. In other words, the disclosed schemes may be applicable to any market sector in which products may be particularly customized by a customer or consumer to his or her desire.

As indicated above, the reference to any particular device or information exchange between a user and a back end BI or gamification system is intended to be illustrative only. In this regard, any commonly-known user personal or public electronic, computing, communicating and/or data display component, whether substantially fixed, or easily mobile, may be incorporated into the overall scheme for automated gamification of user-selectable customization process. It should be recognized that any advantageous use of the systems and methods for gamifying the user-selectable customization process, as described below, or as may be interpreted from the following description, in a manner that not only promotes participation in the user-selectable customization process, but also provides for information exchange pursuant to immersion of a user in a reactive advertising scheme/environment that may benefit from schemes, processes, or techniques such as those discussed in this disclosure is contemplated as being included within the scope of the disclosed exemplary systems and methods.

The disclosed schemes are intended to benefit from a knowledge that customers and/or consumers enjoy games, including but not limited to lotteries, contests, games of chance, casino gaming, and console and portable games, particularly those that utilize individuals' smart phones, tablets, micro-computing devices, and increasingly wearables such as smart watches, computer-aided eyewear, and virtual, augmented and mixed reality immersion components. These are but examples of those existing or emerging technologies that combine portability, personalization, and enable game play and participatory activities. One family of sponsored, ad-based games, “reactive games,” as taught by U.S. Pat. No. 6,606,745 (the disclosure of which is hereby incorporated by reference herein in its entirety), is becoming increasingly popular, in large part due to recent advances in mobile personal technologies that allow users to enter reactive game codes into their devices, or scan QR codes linked to reactive games stored (and even coded and hidden) in their “Reactive” apps.

Users, including retail customers and consumers, increasingly engage in reactive games, which are becoming deployed in mass merchandising and marketing venues and across servicing and advertising networks. The mobile devices that engage in reactive games also can instantly link the user to loyalty networks that may monitor and reward registered users for engaging in reactive games and campaigns. These same devices are able to link consumers with other games, campaigns and events that are designed to allow the users to quickly share their user information (including user identification and specification of user demography), in exchange for the opportunity to have a reward or enhanced experience, service or product.

The disclosed schemes emerged from detailed work regarding the recognition of the above phenomenon and the capacity by which the modern marketplace may be adapted to promote particular customer and consumer brand loyalty by combining the various customer/consumer, merchant, and manufacturing behaviors that are emerging in the modern marketplace. The disclosed schemes advantageously provide merchants and sellers of mass dispensed and measured/measurable products and product components (or virtually any product with user customizable features) linked to computer-aided hardware, software, applications, techniques, processes schemes, systems, devices and/or networks such as the Internet, a mechanism by which to incentivize use of their unique product presentation methodologies and systems by implementing schemes to reward registered customers/consumers for engaging with their products, especially in a more meaningful way that may be beneficial to both the customers/consumers and the merchants and sellers. In embodiments, such an opportunity may be found where individual personal mobile smart-device or mixed reality glassware enabled consumers might be facilitated in their efforts to customize product combinations including, but not limited to sandwich and/or beverage recipes and ingredients/flavor quantities, sandwich recipes and particular combinations of ingredients and the like (including merging the combination of beverage and sandwich selections and ingredients) and then to store (and even uniquely name) the recipe information in the dispensing/preparation equipment (through a dispenser touch screen, via a smart device and an application that can link the user's device to the dispenser, or by any other like means that may employ some manner of NFC, electronically or optically readable communication between the user and the dispenser). As indicated above, once completed, the customer/consumer may be able to retrieve the recipe in the future (via the smart device, dispenser screen, in the event the dispensers are connected to other networked dispensers, at other dispensers, or via transmission as an email, SMS or like message to a user device).

The user experience may be gamified, to make for a more exciting event, building brand loyalty and frequency of use, ideally increasing sales for the manufacturers, merchants and/or sellers.

For beverages, for example, by providing an ability for a user to manually adjust flavor (or component ingredient) quantities, or by otherwise selecting and holding a flavor button (and recording via software an amount of component ingredient dispensed), the unique customized mixture may be recorded, stored, and retrieved, to recreate in the future the unique flavor (measured by quantity of each flavor, or, percentage of each flavor as a sum total of all flavors). This could be accomplished by adding the ability for a customer/ consumer to activate and record a mixology session, or, allow a consumer to somehow enter the “recipe,” in a format that would allow it to be stored and re-ordered and dispensed at later times. The user's smart device could initiate, enable, or otherwise be included in the process, in exchange for the merchant receiving data and other valuable information. A same functionality may be used for ordering ingredients for a sandwich, combinations of ingredients at salad bar, customizing a slice at a pizza bar, adding an entráe or side item in a buffet dining setting, and in other similar situations, reinforcing a retail outlet's dedication to personalized and/or customized complete meals with beverages, and more generally to customized consumer products of virtually any form.

It is anticipated that an ability to have a unique customized experience, as described above, will create enthusiasm and loyalty, which will have a positive impact on a retailer's profitability.

FIG. 1 schematically illustrates an exemplary embodiment of a menu-type display 100, which may be presented on a restaurant tablet-type ordering device, at an ordering kiosk, on a beverage dispenser, according to a handheld mobile device or mixed reality glasses application, via a Web page or the like, by which a user may enter a recipe for a product from selectable options as an entry to a gamified customization scheme according to this disclosure. As shown in FIG. 1, the exemplary menu-type display 100 may include a display screen background 110 that may be, for example, the logoized presentation associated with the QSR with which the exemplary menu-type display 100 is associated.

The exemplary menu-type display 100 may include a camera 120 for taking video or still images, a microphone 130, and one or more speakers 135, all of which combine to provide a mechanism by which a user may interact via audio or video meetings with the exemplary menu-type display 100.

The exemplary menu-type display 100 may include a series of virtual buttons 140-194 by which the user may further interact with the menu-type display 100. The example shown in FIG. 1 is merely illustrative of a typical menu-type display which may be presented to a user on any one of the above-indicated display devices/components.

In the example shown in FIG. 1, a user (or “Reacter,” as users are often termed in a context of reactive advertising schemes) may initiate a recipe-selection session by interacting with the exemplary menu-type display 100, and specifically by selecting one or more sandwich types 140-144. In a similar manner, in the context of a beverage dispenser, the user may initiate the dispenser session via a similar dispenser display. Separately, a React™ application on a user mobile device may scan a code on the exemplary menu-type display 100 (or the dispenser), initiating a log-in sequence, and an ability to order from exemplary menu-type display 100 (and/or a dispenser screen), as a logged in visitor.

Once a series of selections are made by individually customizing a particular recipe to the users choosing by manipulating virtual buttons 150-184 associated with a customization process for the selected sandwich type on the exemplary menu-type display 100, the user may be afforded an opportunity to could then store a recipe, adjust a recipe, add a recipe, or retrieve and dispense a recipe (and, in a case of a beverage dispenser, even go so far as to request a volume to be dispensed, allowing the dispenser to create a “proper” ratio of flavors).

Once user selections have been made, and presuming that a user chooses not to cancel (button 190) his or her selection an opportunity may be provided for the user to review his or her order (button 192) and to pay and simultaneously initiate some manner of gameplay with respect to the selected recipe (button 194). The depicted exemplary “Pay & Play” button 194 may complete the users ordering transaction and transition to a separate screen for collecting information on the particular user in the context of the gamified ordering scheme according to this disclosure.

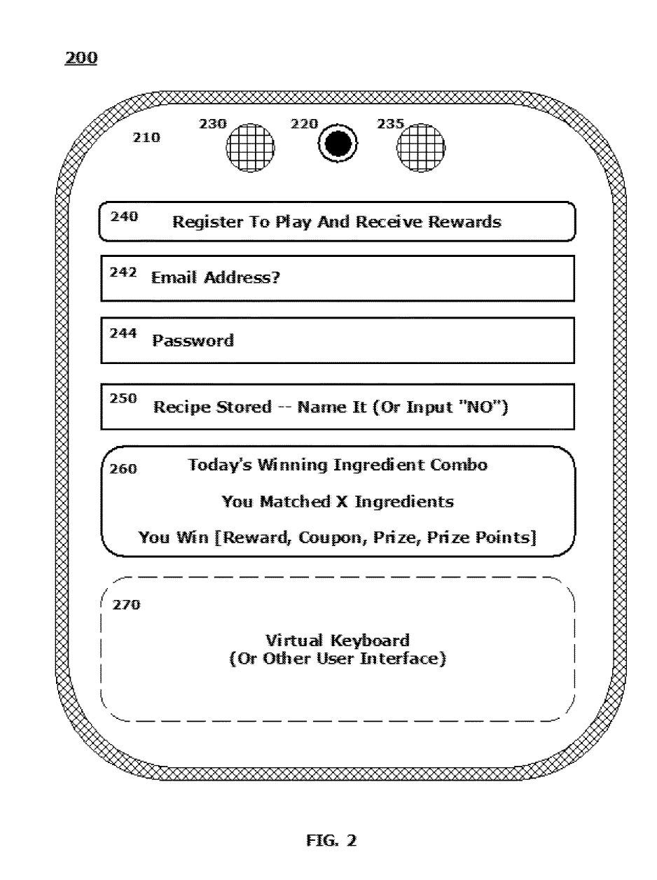

FIG. 2 schematically illustrates an exemplary embodiment of a user data collection display 200, which may be presented on the restaurant tablet-type ordering device, at the ordering kiosk, on the beverage dispenser, or the like, by which a user may be prompted to enter user identifying information to be associated with the recipe for the product selected on the menu-type display of FIG. 1 and according to this disclosure. Similar numbers will be used to represent similar features. The exemplary user data collection display 200 may include a similar background option 210, and for consistency here other elements are renumbered including the camera 220, microphone 230, and one or more speakers 235.

A logoized game banner 240 may be presented to indicate to the user the participation in the gaming mode. Fields may be presented in the exemplary user data collection display 200 for collecting typical user tracking data including a field 242 for collecting a user's email address and a field 244 for collecting user's password. Typical to such interactive displays, the user may be afforded the opportunity, if not pre-registered, to register an email address and a password on a version of the exemplary user data collection display 200.

The exemplary user data collection display 200 may include a field 250 indicating that the user's particular recipe has been temporarily stored and inquiring as to whether the user may desire to name his or her recipe with some manner of personalization or otherwise to decline to name their individual recipe.

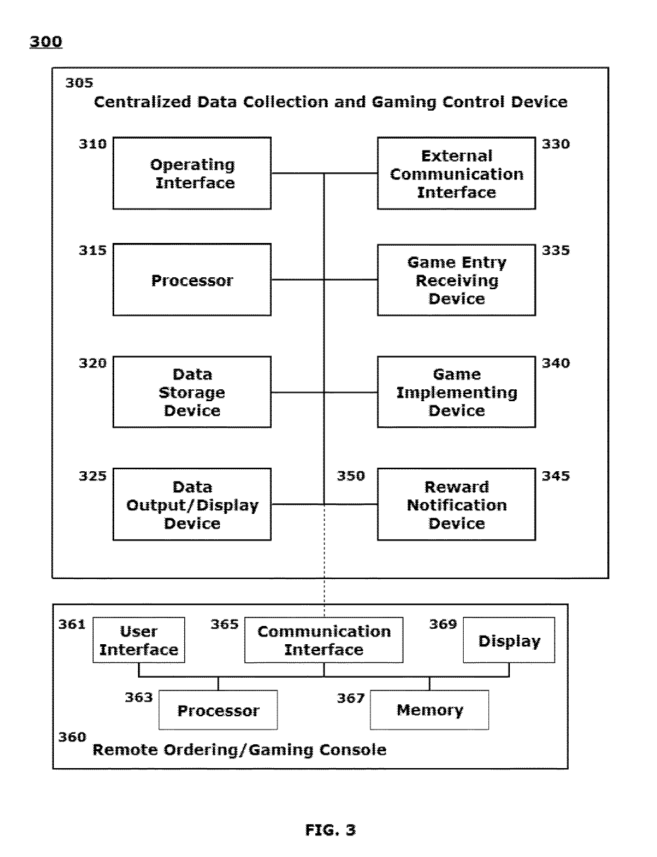

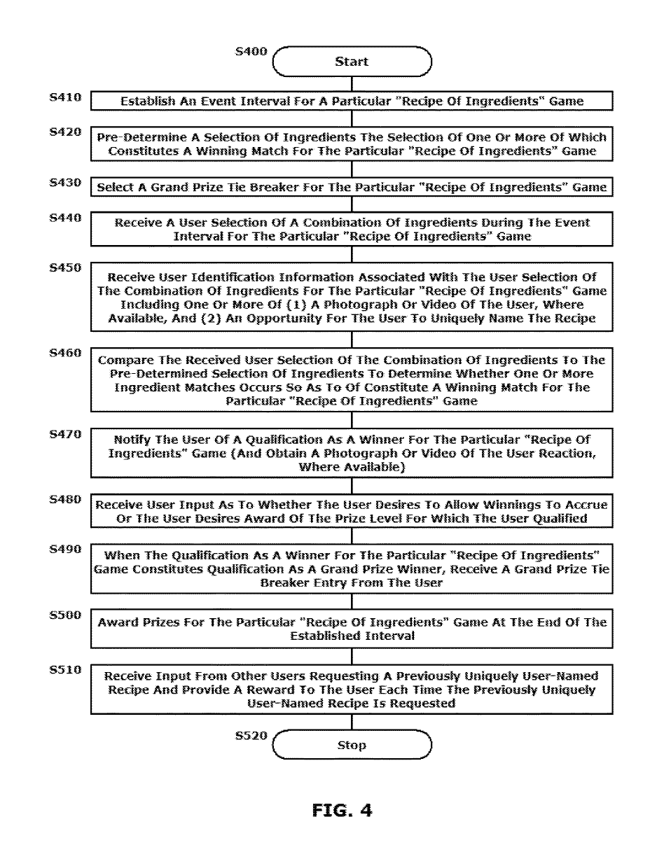

Based on a comparative scheme that is running in the background, and as will be described in detail below with regard to FIGS. 3 and 4, a comparison may be made between the user's recipe selection and a pre-determined collection of ingredients. In a lottery-type hierarchy, one or more of the ingredients selected by the user may be determined to match the pre-determined collection of ingredients for a particular game. A reward display field 260 may be presented on the exemplary user data collection display 200 to inform the user, in some manner, of the pre-determined collection of ingredients, a collection of ingredients that the user matched, and/or a particular reward, coupon, prize, or accumulation of price points that may be associated with the user's selections.

A virtual keyboard 270 may be provided on the user data collection display 200 by which the user can enter any and all of the information desired/required by the user data collection display 200.

In a networked display/dispenser environment, first time orders of a particular ingredient combination or flavor combination (at the particular venue, within the localized chain for the QSR, or across brands nationally) may be named by the creator user. Otherwise, for example, the user may be informed that a name has already been attributed to the particular combination of ingredients. In such an environment, the original creator user of a particular recipe may gain notoriety by having a particular menu combination (and/or a particular soft drink flavor combination) named after (or by) the creator user. The so-named menu (or flavor) combination may then be able to be promoted and virally shared via social media or other means of mass communication including images captured by the camera 220. The creator user (and others) may also see his or her name on the display screen when retrieved by name by others, or when a menu (or flavor) combination is subsequently, dynamically created that matches the original creator user's recipe.

In one gamified iteration, the creator user may be served a reactive ad (and opportunity for a prize) before the exemplary menu-type display screen shown in FIG. 1 (or the drink machine) can be operated, or before the special access is provided, before a recipe can be created, recorded, stored, adjusted, named, or retrieved. Such a reactive session may include an alert, ad(s) and queries on one or both screens shown an exemplary manner in FIGS. 1 and 2, with interaction taking place on one or both screens.

In another gamified “Jackpot” environment, where individual menu-type displays (and/or dispenser devices) may be networked, the QSR, soft drink company, food chain, or some combination of owners, advertiser and promotors, may create a “Daily Secret recipe” that, when ordered precisely, allows the customer/consumer to become eligible to receive a jackpot (reward). The Jackpot recipe could be unique to each machine, each day, or even randomized in each session of a specified length of time or in a specific location, at the machine level, or network wide. Simulating Las Vegas casino-type networked slot machines, each order of a combination of non-jackpot menu items (or dispensing of a non-jackpot beverage recipe) may increase the jackpot a fixed amount, and a single machine, single location, regional, or national network of machines may build and display the cumulative jackpot, awarding the jackpot when the precise recipe is ultimately ordered. Other special prizes may be awarded, or, a jackpot only awarded after one or more subsequent jackpots. As an added skill element, the user may be required to successfully engage in a reactive game, as a precursor to receiving an award, or as a tie breaker in a jackpot environment in which only one jackpot payout is intended.

In a recipe-specific implementing algorithm or scheme, the recipe would include the precise combination of ingredients (or flavors) used. In a case of a modern drink dispenser, the precision may be measured even down to percentage (or dram amount) of each flavor in the recipe mix, to within some percentage (amount) or decimal point. For example, there may be 14 different syrups that can all be added in various quantities, and may be potentially limited to a certain maximum number of the available flavors, e.g., 6 of the 14 different syrups in this example. The percentage of each included flavor may be measured to the exact fixed number in order to be correct. By way of example, the concoction may include 46% Cola, 23% Lemon, and 31% Diet Cola, or they may be measured at a decimal range (46.8% cola, 53.2% lemon), which would exponentially decrease the likelihood of the recipe being selected (allowing therefore for fewer yet necessarily larger jackpots).

In addition to the sandwich and/or beverage example is generally described above, in an exemplary other (pizza) environment, there may exist a fresh pizza bar where visitors receive dough (multiple sizes, and even flavors or gluten-free), and containers or ramekins (even pre-measured) of various ingredients (cheese, sauces, toppings, etc.). The total permutations of pizza recipes may then be in the hundreds of thousands or even millions. For example, with 14 toppings (allowing doubling) to choose from, and three dough sizes and three dough flavors, a five-topping pizza results in millions of combinations of pizza (and that assumes the game tells users the number of toppings required to win). At each such pizza location, visitors can order their pizza via an app (and the ingredients are ready when they get to the location), create the pizza themselves at a pizza bar, and place it on a conveyor for high temp cooking (or made by a pizzaiola in the Neapolitan vernacular), perhaps in a manner where the guests can see it cooking (maybe via cameras and displays) or widowed conveyor ovens. When the combination is entered into the menu-type display, computer, POS device or otherwise, the user is, in the manner described above, able to name the pizza in the system, for future easy retrieval. If the pizza being ordered meets the award-, reward- or jackpot-specified combination of ingredients for that day, time, region or the like, a prize may be awarded. And, if the customer is the first to order a combination at that location, it may be named (perhaps for all time or for a limitedly specified period), a digital photo may be taken of the consumer, and may be printed and signed, and added to an electronic Signature Wall of Fame (along with the smiling customer's name and face). Each such pizza location may have different pictures, names, and pizzas on the Signature Wall of Fame.

In another exemplary environment, a beverage distribution or manufacturing company may cooperate with a QSR or other food service outlet, and create a tandem beverage and meal combination promotion. Such cooperation may advantageously provide customers/consumers with a promotion unique to the marketplace. Separately, the beverage company may retain an ability to conduct similar, though unique, promotions with other QSRs or yet other food service outlets. Alternatively, a QSR might be able to utilize the tandem “beverage and foodstuff mixology” promotion (and optional addition of jackpots and reactive elements) as a unique, exciting reason for consumers to visit the QSR, leveraging a period of exclusivity with the beverage company, to help differentiate the QSR from other QSRs. In instances, the exclusivity could be regional, national, or food category specific. The exclusivity request could be leveraged as a condition of the QSR promoting and retailing the participating beverage over another competing choice. Alternatively, the beverage company could offer exclusivity of the beverage-only or tandem promotion to entice the QSR or other food outlet to enter into exclusivity and co-branding agreements.

FIG. 3 illustrates a block diagram of an exemplary system 300 for implementing a menu and user recipe type gaming scheme according to this disclosure. As shown in FIG. 3, the exemplary system 300 may include a centralized data collection and gaming control device 305 linked to a plurality of remote ordering/gaming consoles 360 for executing the gamification scheme according to this disclosure.

The exemplary device 305 may include an operating interface 310 by which a user, as a gaming host, may communicate with the exemplary system 300. The operating interface 310 may provide the host an opportunity to initiate an automated recipe of ingredients game and to input any parameters appropriate to the conduct of the automated game. The operating interface 310 may be configured as one or more conventional mechanisms common to computing and/or communication devices that may permit the host to input information to the exemplary system 300. The operating interface 310 may include, for example, a conventional keyboard, a touchscreen with “soft” buttons or with various components for use with a compatible stylus, a microphone by which the host may provide oral commands to the exemplary system 300 to be “translated” by a voice recognition program, or other like device by which a user may communicate specific operating instructions to the exemplary system 300.

The exemplary device 305 may include one or more local processors 315 for individually operating for carrying into effect the disclosed schemes in the exemplary system 300. The processor 315 may carry out routines appropriate to operation of the exemplary system 300, and may undertake data manipulation and analysis functions appropriate to the game. Processor(s) 315 may include at least one conventional processor or microprocessor that interprets and executes instructions to direct specific functioning of the exemplary system 300, and control of the automated gamification implementation according to this disclosure.

The exemplary device 305 may include one or more data storage devices 320. Such data storage device(s) 320 may be used to store data or operating programs to be used by the exemplary system 300, and specifically the processor(s) 315 in carrying into effect the various participant interacting, game displaying and rewards notification functions of the disclosed gamification schemes. At least one of the data storage device(s) 320 may be used to store the gamification application and to temporarily store in-process recipe and user participant information received from user manipulation of one or more of the plurality of remote ordering/gaming consoles 360. At least one of the data storage device(s) 320 may be used to store particular identification information that may be collected incumbent to individual participants requesting to play the game.

The data storage device(s) 320 may include a random access memory (RAM) or another type of dynamic storage device that is capable of storing updatable database information, and for separately storing instructions for execution of system operations by, for example, processor(s) 315. Data storage device(s) 320 may also include a read-only memory (ROM), which may include a conventional ROM device or another type of static storage device that stores static information and instructions for processor(s) 315. Further, the data storage device(s) 320 may be integral to the exemplary facility 305, or may be provided external to, and in wired or wireless communication with, the exemplary system 300 and/or the exemplary facility 305, including as cloud-based storage components.

The exemplary device 305 may include at least one data output/display device 325, which may be configured as one or more conventional mechanisms that output information to a user, in this case a host, on a progress of the game/domestication. The data output/display device 325 may be used to indicate to the host information regarding a compilation of recipes, which are user-entered, for a particular game. It is not necessary that the host monitor the actual conduct of the automated game by the exemplary system 300, but the host is afforded that option.

The exemplary device 305 may include one or more separate external communication interfaces 330 by which the exemplary device 305 may communicate with one or more of the plurality of remote ordering/gaming consoles 360, which may be in wired or wireless communication with the exemplary device 305.

The exemplary device 305 may include a game entry receiving device 335 that may be used to receive and store participant recipe and registration/identification information for individuals participating in the automated recipe of ingredients game. In addition to receiving prospective participant registration/identification information, the game entry receiving device 335 may be usable to interact with the remote ordering/gaming console 360 to receive user-selected recipes of ingredients as entries in the gamification scheme.

The exemplary device 305 may include a game implementing device 340 that may execute functions for carrying into effect the automated gamification according to the disclosed schemes in the exemplary device 305. The game implementing device 340 may itself be a function of the processor 315, or may exist in the exemplary device 305 as a stand-alone component.

The game implementing device 340 may accept input from the game entry receiving device 335 and may separately undertake the pre-determination of the selection of ingredients/features to be established for matching with received user inputs. The game implementing device 340 may undertake the comparison of the received user inputs with the pre-determine selection of ingredients/features to (1) determine when one or more matches exists, and (2) signal the reward notification device 345 when one or more matches is determined to exist.

The exemplary device 305 may include a reward notification device 345 by which, when a participant is determined to have won a prize, award, reward or the like, in the form of, for example, merchandise, discounts, coupons, cash and/or other incentives, the user may be immediately notified. Like the game implementing device 340 above, the reward notification device 345 may be a function of the processor 315, or a stand-alone device, either of which may present reward information to the remote ordering/gaming console 360 to be displayed, for example, on a display 369 of the remote ordering/gaming console 360.

The exemplary system 300 may include communications between the exemplary device 305 and one or more remote ordering/gaming consoles 360, each of which may themselves include user interface 361, processor 363, communication interface 365, a memory 367, and a display 369. The user, as a participant in a recipe of ingredients menu gamification scheme may employ the plurality of remote ordering/gaming console 364 user interaction in the exemplary system 300 as it carries into effect the disclosed schemes for implementing the automated gamification. It should be noted that one or more of the remote ordering/gaming console 360 by which a user may order a particular recipe of ingredients and participate in the automated game may be, in addition to the many device the catalogued above, user-wearable devices such as, for example, wearable computer/communicating display glasses and/or watches, biometric sensors, virtual reality (or immersion) devices including goggles, helmets, tactile gloves and the like, and other known or developed wearable components for carrying out one or more of computing and/or communicating functions allowing users to communicate with the exemplary system 300.

All of the various components of the exemplary system 300, as depicted in FIG. 3, may be connected internally, and to one or more external components by one or more data/control busses 350. These data/control busses 350 may provide wired or wireless communication between the various components of the exemplary system 300, and particularly the exemplary device 305 whether all of the components of the exemplary device 305 are housed integrally in, or are otherwise external and connected to the exemplary device 305.

It should be appreciated that, although depicted in FIG. 3 as an essentially integral unit, the various disclosed elements of the exemplary device 305 may be arranged in any combination of sub-systems as individual components or combinations of components, integral to a single unit, or external to, and in wired or wireless communication with the single unit of the exemplary device 305. Wireless communications may be by RF radio devices, optical interfaces, NFC devices and other wireless communicating devices according to RF, Wi-Fi, WiGig and other like communications protocols. In other words, no specific configuration as an integral unit, or as a support unit, is to be implied by the depiction in FIG. 3. Further, although depicted as individual units for ease of understanding of the details provided in this disclosure regarding the exemplary system 300, it should be understood that the described functions of any of the individually-depicted components may be undertaken, for example, by one or more processors 315 (and 363) connected to, and in communication with, one or more data storage device(s) 320 (and memor(ies) 367.

The disclosed embodiments may include an exemplary method for implementing a menu and user recipe type gaming scheme. FIG. 4 illustrates a flowchart of such an exemplary method. As shown in FIG. 4, operation of the method commences at Step S400 and proceeds to Step S410.

In Step S410, an event interval or particular “recipe of ingredients” automated game may be established. Operation of the method proceeds to Step S420.

In Step S420, a selection of ingredients may be pre-determined. The pre-determined selection of ingredients may establish the gaming criteria for the particular game such that selection of one or more of the pre-determined selection of ingredients by a user constitutes a winning match for the particular game. Operation of the method proceeds to Step S430.

In Step S430, depending on a construct of the game, and the game prize full, a grand prize tiebreaker may be selected for the particular game. When necessary, the grand prize tiebreaker may be used to ensure that the number of grand prizes (jackpots) awarded for a complete match of a particular user-input recipe of ingredients against the pre-determined selection of ingredients is limited. Operation of the method proceeds to Step S440.

In Step S440, a user selection of a combination of ingredients may be received from one or more user input devices in the manner enumerated above and during the event interval of a particular game. Operation of the method proceeds to Step S450.

In Step S450, user identification information associated with the user selection of the combination of ingredients for the particular game may be received. The user identification information may include one or more of (1) a photograph or video of the user, where available, and (2) an opportunity for the user to uniquely name the recipe associated with the particular selection of a combination of ingredients. Operation of the method proceeds to Step S460.

In Step S460, the received user selection of the combination of ingredients according to the user's recipe may be compared to the pre-determined selection of ingredients to determine whether one or more ingredients matches occur. The occurrence of one or more ingredients matches may be considered to constitute a winning match for the particular game. Operation of the method proceeds to Step S470.

In Step S470, the user may be notified as to his or her qualification as a winner for the particular game. Where available, a photograph or video of the user's reaction at being so notified may be obtained. Operation of the method proceeds to Step S480.

In Step S480, user input as to whether the user desires to allow winnings to accrue for the user desires award of the price level for which the user qualified may be received. Operation of the method proceeds to Step S490.

In Step S490, when a user is determined to have qualified as a grand prize (or jackpot) winner for the particular game, the user may be prompted to respond with certain tie breaker information for the reasons indicated above. This tiebreaker information may be ultimately evaluated against the pre-selected tiebreaker information in order to determine an ultimate jackpot winner from among those users who are otherwise qualified to win the grand prize or jackpot. Operation the method proceeds to Step S500.

In Step S500, prizes may be awarded for the particular game at the end of the established interval, or, for smaller prizes, those prizes may be awarded during the progress of the game. Award of the prizes may be notified to the users based on interaction with any of the communications schemes established between individual users and a centralized gamification device or facility. Operation the method proceeds to Step S510.

In Step S510, input may be received from other users requesting a previously uniquely user-named recipe. In such instances, additional rewards may be provided to the original user each time, or each series of times, that the previously uniquely user-named recipe as requested. Operation of the method proceeds to Step S520, where operation of the method ceases.

The disclosed embodiments may include a non-transitory computer-readable medium storing instructions which, when executed by a processor may cause the processor to execute all, or at least some, of the steps of the method outlined above.

The above-described exemplary systems and methods reference certain conventional components to provide a brief, general description of suitable operating and presentation scheme implementing environments in which the subject matter of this disclosure may be undertaken for familiarity and ease of understanding. Although not required, embodiments of the disclosure may be provided, at least in part, in a form of hardware circuits, firmware, or software computer-executable instructions to carry out the specific functions described. These may include individual program modules executed by processors.

Those skilled in the art will appreciate that other embodiments of the disclosed subject matter may be practiced in myriad configurations for carrying into effect the disclosed automated gamification schemes with applications hosted on a broad spectrum of computing and communicating devices.

As indicated above, embodiments within the scope of this disclosure may include computer-readable media storing computer-executable instructions or data structures that can be read and executed by one or more processors for controlling the presentation processes for gaming matrices according to the disclosed schemes, and for carrying into effect the overall gaming schemes. Such computer-readable media can comprise RAM, ROM, EEPROM, CD-ROM, flash drives, data memory cards or other analog or digital data storage device that can be used to carry or store desired program elements or steps in the form of accessible computer-executable instructions or data structures.

Computer-executable instructions include, for example, non-transitory instructions and data that can be executed and accessed respectively to cause a processor, for example, in an automated game implementing device or system to perform certain of the above-specified data acquisition, game implementation, and display functions. Computer-executable instructions may also include program modules that are remotely stored for access and execution by a processor.

The exemplary depicted sequence of executable instructions or associated data structures represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 4, except where a particular method step is a necessary precondition to execution of any other method step. Separately, not all of the depicted steps of the method shown in FIG. 4 need to be implemented in any particular embodiment.

The above description is not intended to be specifically limiting to the described schemes, but rather is intended to provide a framework in which an individual customer/consumer may select a unique combination of product elements, ingredients or features with each unique combination being entered into a prize pool. The prize pool may provide for prizes to be awarded in specified locations and under specifically limiting sets of circumstances including according to time constraints and/or when a particularly selected combination of product elements, ingredients or features meets a predetermined menu for those product elements, ingredients or features.

Although the above description may contain specific details, they should not be construed as limiting the claims in any way. Other configurations of the described embodiments of the disclosed systems and methods are part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A system for implementing an automated game, comprising:
an operating interface that is configured to receive an input regarding a user selection of one or more features for a customizable product;
a gamification device that is configured to
store a menu of user selectable features for the customizable product,
select individual ones of the user selectable features as a selected subset from the menu of user selectable features,
compare a received user input regarding the user selection of the one or more features to the selected subset to determine a number of matching individual features resulting from the comparison, and
determine a user eligibility for an award based on the number of matches exceeding a threshold; and
a notification device that is configured to notify the user of the determined eligibility for the award.

2. The system of claim 1, the operating interface being further configured to obtain user identification information associated with the received user input regarding the user selection of the one or more features.

3. The system of claim 2, the user identification information including a user-selected name for the user selection of the one or more features.

4. The system of claim 3, the gamification device being further configured to
receive a user input regarding a previously received user-selected name; and
determine a user eligibility for an additional award based on the received user input regarding the previously received user-selected name.

5. The system of claim 1, the gamification device being further configured to
select a particular parameter for one of the features in the selected subset;
determine the user eligibility for a jackpot award based on the user selection of the one or more features matching all of the features in the selected subset; and
applying the particular parameter for the one or more features in the selected subset to determine an overall jackpot award winner from among qualifying users.

6. The system of claim 1, further comprising a camera that is configured to monitor user interaction with the operating interface.

7. The system of claim 6, the operating interface and the notification device being components of a single integral unit.

8. The system of claim 7, the gamification device being further configured to command the camera to capture images of the user being notified of the determined eligibility for the award as additional user identification information.

9. The system of claim 1, the operating interface being one of a tablet ordering device, a kiosk ordering device, a computing device, a user handheld communicating device, and a user-wearable input/output computing device component.

10. The system of claim 1, further comprising a storage device that is configured to store a database of input user selections of the one or more features for the customizable product with associated user identification information.

11. A method for implementing an automated game, comprising:
storing, with a processor, a menu of user selectable features for a customizable product;
selecting, with the processor, individual ones of the user selectable features from the menu as a selected subset of the user selectable features;
receiving, with the processor, an input regarding a user selection of one or more features for the customizable product;
comparing, with the processor, the received input regarding the user selection of the one or more features to the selected subset to determine a number of matching individual features resulting from the comparison;
determining, with the processor, a user eligibility for an award based on the number of matches exceeding a threshold; and
directing, with the processor, a notification device to notify the user of the determined eligibility for the award.

12. The method of claim 11, further comprising:
receiving, with the processor, user identification information associated with the received user input regarding the user selection of the one or more features.

13. The method of claim 12, the user identification information including a user-selected name for the user selection of the one or more features.

14. The method of claim 13, further comprising:
receiving, with the processor, a user input regarding a previously received user-selected name; and
determining, with the processor, a user eligibility for an additional award based on the received user input regarding the previously received user-selected name.

15. The method of claim 1, further comprising:
selecting, with the processor, a particular parameter for one of the features in the selected subset;
determining, with the processor, user eligibility for a jackpot award based on the user selection of the one or more features matching all of the features in the selected subset; and
applying, with the processor, the particular parameter for the one or more features in the selected subset to determine an overall jackpot award winner from among qualifying users.

16. The method of claim 11, the inputs from the user being received by the processor from an operating interface with which the user interacts to order the customizable product.

17. The method of claim 16, further comprising providing a camera associated with the operating interface,
wherein:
the notification device is integral to the operating interface, and
the processor commands the camera to capture images of the user being notified of the determined eligibility for the award.

18. The method of claim 16, the operating interface being one of a tablet ordering device, a kiosk ordering device, a computing device, a user handheld communicating device, and a user-wearable input/output computing device component.

19. The method of claim 11, further comprising storing, in a database, input user selections of the one or more features for the customizable product with associated user identification information.

20. A non-transitory computer-readable data storage medium storing instructions that, when executed by a processor, cause the processor to execute the steps of a method for implementing an automated game, comprising:
storing a menu of user selectable features for a customizable product;
selecting individual ones of the user selectable features from the menu as a selected subset of the user selectable features;
receiving an input regarding a user selection of one or more features for the customizable product;
comparing the received input regarding the user selection of the one or more features to the selected subset to determine a number of matching individual features resulting from the comparison;
determining a user eligibility for an award based on the number of matches exceeding a threshold; and
notifying the user of the determined eligibility for the award.
